(19) United States
(12) Patent Application Publication
(10) Pub. No.: US 2025/0138885 A1
(43) Pub. Date: May 1, 2025

(54) METHODS AND SYSTEMS FOR RECLAIMING SYSTEM RESOURCES IN AN ELECTRONIC DEVICE

(71) Applicant: Samsung Electronics Co., Ltd., Suwon-si (KR)

(72) Inventor: Bittu Kumar SINGH, Noida (IN)

(21) Appl. No.: 18/797,001

(22) Filed: Aug. 7, 2024

Related U.S. Application Data
(63) Continuation of application No. PCT/KR2024/010857, filed on Jul. 25, 2024.

(30) Foreign Application Priority Data
Oct. 27, 2023 (IN) 202311073437

(51) Int. Cl. G06F 9/50; G06F 11/34

(52) U.S. Cl. CPC G06F 9/5022; G06F 9/5033; G06F 11/3452

(57) ABSTRACT

A method and a system for reclaiming system resources in an electronic device are provided. The method includes identifying an initialization of an activity corresponding to a first application associated with the electronic device, determining whether a combination of the activity and the first application is defined in a resource pool database, upon determining that the combination of the activity and the first application is not defined in the resource pool database: monitoring resource consumption by the activity, and storing the combination of the activity and the first application with the monitored resource consumption in the resource pool database, and upon determining that the combination of the activity and the first application is defined in the resource pool database, reclaiming the system resources corresponding the combination of the activity and the first application.

### CROSS-REFERENCE TO RELATED APPLICATION(S)

This application is a continuation application, claiming priority under § 365 (c), of an International application No. PCT/KR2024/010857, filed on Jul. 25, 2024, which is based on and claims the benefit of an Indian Patent Application number 202311073437, filed on Oct. 27, 2023, in the Indian Intellectual Property Office, the disclosure of which is incorporated by reference herein in its entirety.

### TECHNICAL FIELD

The disclosure relates to electronic devices. More particularly, the disclosure relates to methods and systems for reclaiming system resources in an electronic device.

### BACKGROUND ART

Mobile devices, particularly smartphones, have become ubiquitous in modern society, serving as powerful tools for communication, entertainment, and productivity, with an ever-expanding array of smartphone applications. As the capabilities and demands of the smartphone applications have continued to grow, so too have the challenges associated with efficiently allocating device resources, such as Central Processing Unit (CPU), memory, and network bandwidth, to meet the diverse and often competing requirements of these applications.

Moreover, most of the smartphone applications include some time bound activities that need to be completed in a predefined time. Any delay in said predefined time results in failure error such as, request timeout, delay error, etc. Thus, it is essential to fulfill the demand for resources of such smartphone applications to enable an effective working of the smartphone applications.

A process of efficiently managing and freeing up system resources, such as memory (Random Access Memory (RAM)), CPU, and battery power, that are being used by various applications and processes may be termed resource reclaiming. A request for the resource reclaiming generally includes an amount of resources required to complete the activity or the function of the smartphone application. Many times, the number of requests for a certain amount of resource reclaim is too high which leads to an overall delay in activity completion time and causes serious issues like app crash, reboot, and poor user interaction.

A conventional resource reclaiming process includes fulfilling the recent request without considering the impact of such request on other requests. Further, the conventional approach to perform resource allocation experiences a significant delay as a release of the resources only starts after a current allocation request is done. Moreover, the conventional resource reclaiming process experiences issues like thread block, resource contention, and limited resource availability.

Accordingly, there is a need to overcome at least the above challenges associated with conventional techniques of dealing with resource reclaim.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide methods and systems for reclaiming system resources in an electronic device.

Additional aspects will be set forth in part in the description which follows and, in part, will be apparent from the description, or may be learned by practice of the presented embodiments.

In accordance with an aspect of the disclosure, a method for reclaiming system resources in an electronic device is provided. The method includes identifying an initialization of an activity corresponding to a first application associated with the electronic device, determining whether a combination of the activity and the first application is defined in a resource pool database, upon determining that the combination of the activity and the first application is not defined in the resource pool database: monitoring resource consumption by the activity, and storing the combination of the activity and the first application with the monitored resource consumption in the resource pool database, And upon determining that the combination of the activity and the first application is defined in the resource pool database, reclaiming, using a reinforced learning (RL) model and the resource pool database, the system resources corresponding the combination of the activity and the first application.

In accordance with another aspect of the disclosure, a system for reclaiming system resources in an electronic device is provided. The system includes memory storing one or more computer programs, and one or more processors communicatively coupled to the memory, wherein the one or more computer programs include computer-executable instructions that, when executed by the one or more processors individually or collectively, cause the system to identify an initialization of an activity corresponding to a first application associated with the electronic device, determine whether a combination of the activity and the first application is defined in a resource pool database, upon determining that the combination of the activity and the first application is not defined in the resource pool database, monitor resource consumption by the activity, and to store the combination of the activity and the first application with the monitored resource consumption in the resource pool database; and upon determining that the combination of the activity and the application is defined in the resource pool database, reclaim, using a reinforced learning (RL) model and the resource pool database, the system resources corresponding to the combination of the activity and the first application.

In accordance with another aspect of the disclosure, one or more non-transitory computer-readable storage media storing one or more computer programs including computer-executable instructions that, when executed by one or more processors of an electronic device, cause the electronic device to perform operations are provided. The operations include identifying an initialization of an activity corresponding to a first application associated with the electronic device, determining whether a combination of the activity and the first application is defined in a resource pool database, upon determining that the combination of the activity and the first application is not defined in the resource pool database, monitoring resource consumption by the activity and storing the combination of the activity and the first application with the monitored resource consumption in the resource pool database, and upon determining that the combination of the activity and the first application is defined in the resource pool database, reclaiming, using a reinforced learning (RL) model and the resource pool database, the system resources corresponding the combination of the activity and the first application.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a schematic workflow of a system for reclaiming system resources in an electronic device, according to an embodiment of the disclosure;

FIG. 2 illustrates a schematic block diagram of the system for reclaiming system resources in the electronic device, according to an embodiment of the disclosure;

FIG. 3 illustrates a schematic workflow of various modules of the system, according to an embodiment of the disclosure;

FIG. 4 illustrates a flow chart of a method for reclaiming system resources in the electronic device, according to an embodiment of the disclosure;

FIG. 5 illustrates a flow chart of a method of learning for reclaiming system resources in the electronic device, according to an embodiment of the disclosure;

FIG. 6 illustrates a schematic block diagram of a workflow of the system for reclaiming system resources, according to an embodiment of the disclosure;

FIG. 7 illustrates a schematic workflow of an activity detection process module, according to an embodiment of the disclosure;

FIG. 8 illustrates a schematic workflow of a monitoring process module, according to an embodiment of the disclosure;

FIG. 9 illustrates a schematic workflow of a resource reclaim module, according to an embodiment of the disclosure;

FIG. 10 illustrates a process flow of a method for reclaiming system resources in the electronic device, according to an embodiment of the disclosure; and

FIG. 11 illustrates a process flow of a Reinforced Learning (RL) model for reclaiming system resources in the electronic device, according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

Embodiments of the disclosure are directed towards a method and a system for reclaiming system resources in an electronic device. A key objective of the disclosure is to apply Reinforcement Learning (RL) model to adjust an amount of resources reclaimed from/for an activity (operation/feature). This allows the system to reclaim the minimum amount of resources necessary to ensure that the activity continues to function properly, while also preventing the system from becoming overloaded. Further, the method uses a resource pool table to store information about the resource consumption of each activity (operation/feature) for an application. This allows the system to quickly and easily determine the amount of resources that can be reclaimed for an activity, without having to repeat the reclaim process multiple time for a certain amount of resource. Moreover, the system improves the performance and efficiency of the electronic device, by reclaiming system resources from unrelated (non-neighbor) activities. Thus, the disclosure improves the overall performance of the system and prevents the system from becoming overloaded with resource allocation requests.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

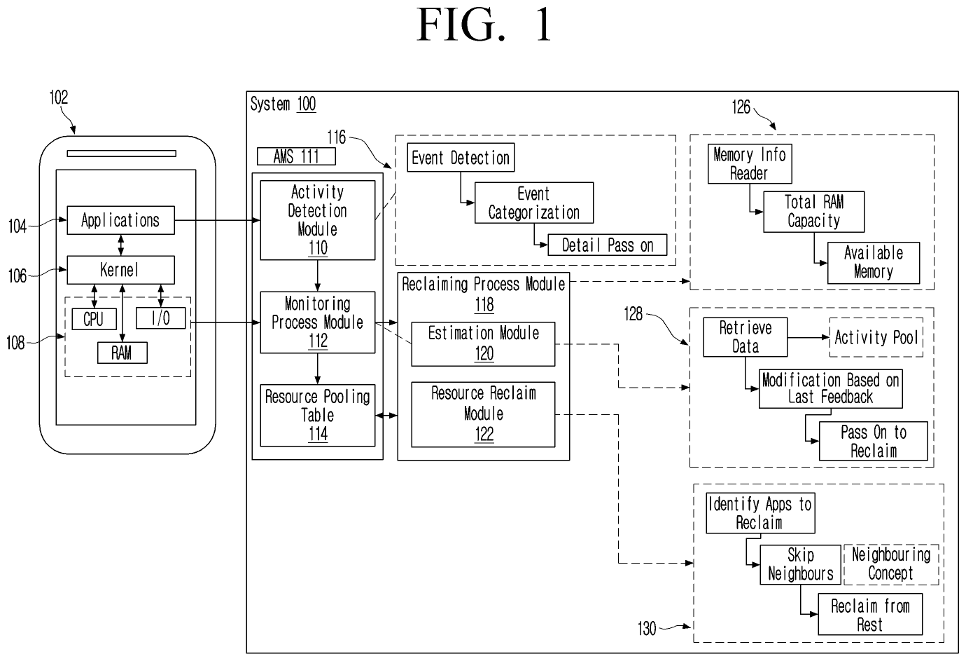

FIG. 1 illustrates a schematic workflow of a system 100 for reclaiming system resources in an electronic device 102, according to an embodiment of the disclosure.

Referring to FIG. 1, in one embodiment, the system 100 may be a standalone entity which is communicably coupled to the electronic device 102 via a network (not shown). In another embodiment, the system 100 may be implemented at the electronic device 102. Further, examples of the electronic device 102 may include, but are not limited to, a smartphone, a tablet, a laptop, a portable computing device, a television, an Internet of Thing (IoT) device, a Machine-to-Machine (M2M) device, or any other device within limited storage to perform multiple tasks simultaneously.

The electronic device 102 may include one or more applications 104 (interchangeably referred to as “the applications 104”) to enable a user of the electronic device 102 to access or perform desired functions/operations. The applications 104 may be referred to as a set of instructions which are executed on the electronic device 102 to enable the user to utilize capabilities and components of the electronic device 102 to perform the desired functions/operations. For instance, the electronic device 102 may include the one or more applications 104 related to social media platforms, camera sensors, entertainment, productivity, health and fitness, online shopping, and so forth. The applications 104 may be either installed on the electronic device 102 or an online server (now shown) that is communicably coupled with the electronic device 102. The applications 104 may utilize various resources 108 (interchangeably referred to as “the system resources 108”) of the electronic device 102 to perform the corresponding function/operations, such resources include, but are not limited to, a Central Processing Unit (CPU), memory resources, power resources, and the like. Further, the electronic device 102 may operation on a specific type of Operating System (OS) such as, but not limited to, Tizen®, Android®, iOS®, Windows®, etc., and each of the applications 104 may be designed to support the corresponding OS of the electronic device 102.

The electronic device 102 may also include a kernel 106. The kernel 106 may be communicably coupled with the applications 104 and the resources 108. The kernel 106 may be defined as a core component of the OS of the electronic device 102 that is responsible for managing the system resources 108 and controlling an execution of the functions/operations of the applications 104. The kernel 106 may act as an intermediary between the system resources 108 and applications 104. The kernel 106 provides a standardized interface for the applications 104 to interact with the system resources 108. The kernel 106 is configured to allocate CPU time and memory resources to different applications 104 and ensure efficient execution of each of the applications 104 without interfering with each other. In the disclosure, the kernel 106 operates in communication with the system 100 to allocate the system resources 108 effectively and efficiently. While the kernel 106 is also configured to perform various other generic operations required for the effective execution of the applications 104 and management of the system resources 108, a description of such operations has been omitted for the sake of brevity.

In an embodiment, the system resources 108 may include, but are not limited to, CPU, memory (specifically, Random Access Memory (RAM)), and Input/Output (I/O) resources. Examples of the I/O resources may include, but are not limited to, a touchscreen, a camera, a speaker, a microphone, a keypad, an accelerometer, and so forth.

The system 100 may be communicably coupled with the electronic device 102. Further, system 100 as a whole or in-part may be implemented at the electronic device 102. The system 100 may include an activity detection module 110. The activity detection module 110 may be communicably coupled with an Activity Monitoring Service (AMS) 111 and is configured to monitor the one or more applications 104 or the resources 108. Specifically, the activity detection module 110 in communication with the AMS may be configured to detect an event corresponding to the one or more applications 104 or one or more system resources 108. Example of such events may include, but is not limited to, the initialization of an activity of an application, an indication of initialization of the application, an initialization of a resource, an allocation of a resource, utilization of the resource, and so forth. In an embodiment, the activity detection module 110 may be configured to perform operations as highlighted by block 116. The activity detection module 110 may be configured to perform event detection corresponding to one of the applications 104 or the system resources 108. Next, the activity detection module 110 may be configured to perform event categorization to categorize the detected event. The activity detection module 110 may be configured to implement techniques such as Machine Learning (ML) technique, and pattern recognition technique to categorize the detected event in a corresponding category. Different types of the events may include, but are not limited to, phone calls, text messages, app launches, screen touches, and button presses. Accordingly, the activity detection module 110 may be configured to categorize the detected event based at least on a type of the detected event. Next, the activity detection module 110 may be configured to pass on the details corresponding to the detected event to other modules and/or components of the system 100.

The system 100 further includes a monitoring process module 112 configured to monitor the consumption of the system resources 108 by the one or more applications 104. Specifically, the monitoring process module 112 may be configured to identify an activity (i.e., an operation/function) corresponding to the application 104 and monitor consumption/utilization of the system resources by the identified activity. The monitoring process module 112 is configured to share the activity and corresponding information related to the system resources 108 with the other modules and/or the components of the system 100. For instance, the monitoring process module 112 may be configured to share the activity and corresponding information related to the application 104 and the system resources 108 with a resource pooling table 114 (may also be referred to as “the resource pool database 114”) or a reclaiming process module 118.

The resource pooling table 114 may be defined as a database configured to store information related to activities, and associated applications and resource consumption. The resource pooling table 114 may include information corresponding to a combination of activities and associated applications along with the amount of resources required to effectively execute the activities. In an embodiment, the resource pooling table 114 may include a hash value corresponding to each combination of an activity and associated application which is mapped to a corresponding resource consumption. In one non-limiting example, the resource pooling table 114 may include one or more sub-tables such as, but not limited to, an activity pool table, a hash pool table, and an Artificial Intelligence (AI)/ML table. The resource pooling table 114 or the corresponding sub-tables have been explained in detail in the following description.

The system 100 includes the reclaim process module 118. The reclaim process module 118 may be configured to be communicably coupled with the monitoring process module 112. The reclaim process module 118 may be configured to reclaim the system resources 108 corresponding the combination of the activities and the corresponding applications 104 using a Reinforced Learning (RL) model and the resource pooling table 114. The reclaim process module 118 enables effective reclaiming of resources for the activities and/or the applications 104. The reclaim process module 118 may be configured to determine availability of the system resources 108 prior to performing the reclaiming of the system resources 108 for an activity and/or the corresponding application 104. For instance, the reclaim process module 118 is configured to perform operations as illustrated by block 126. The reclaim process module 118 may include a memory info reader configured to read and/or identify availability of the memory resources. Next, the reclaim process module 118 may identify a total available resource, for instance, total RAM capacity. Thereafter, the reclaim process module 118 may output an available memory resource. The reclaim process module 118 may be configured to perform similar operations for other resources such as, but not limited to, the CPU, the I/O resources, and so forth.

The reclaim process module 118 may also include an estimation module 120 and a resource reclaim module 122. The estimation module 120 may be configured to retrieve information corresponding to the activity and/or the associated application 104 based on a previous history of the user. Next, the estimation module 120 may estimate the amount of resources required for the activity and/or the associated application 104 based on the previous history. The estimation module 120 may be configured to perform operations as illustrated by block 128. The estimation module 120 may be configured to retrieve data from an activity pool that may be a part of the resource pooling table 114. In one embodiment, the retrieved data may include resource allocation to a previously executed activity and/or application and corresponding feedback. The estimation module 120 may be configured to modify the information i.e., the resource allocation for the previously executed activity and/or the application based on the corresponding feedback and share an output with the other the modules and/or the components of the system 100. Specifically, the estimation module 120 may be configured to share the output with the resource reclaim module 122.

The resource reclaim module 122 may be configured to reclaim the system resources 108 corresponding the combination of the activities and the corresponding applications 104 based on the information shared by the estimation module 120. The resource reclaim module 122 may be configured to effectively reclaim the system resources 108 required for the activities and the corresponding applications 104 using a neighboring technique. The resource reclaim module 122 may be configured to perform operations illustrated by block 130. First, the resource reclaim module 122 may be configured to identify the applications to reclaim the system resources 108. Next, the resource reclaim module 122 applies the neighboring technique (concept) to skip the neighboring applications and reclaim the system resources 108 from the non-neighboring applications. For instance, a plurality of entertainment applications, a social media application, a web browsing application, a gaming application, a messaging application, and one or more online shopping applications are running on the electronic device 102. When an event corresponding to a new online shopping application is detected, the system 100 may categorize the plurality of entertainment applications, the social media applications, and the one or more online shopping applications as neighboring applications and the rest of applications, i.e., the web browsing application, the gaming application, and the messaging application may be categorized as non-neighboring applications. Accordingly, the system 100 may terminate one or more operations and/or the whole application categorized in the non-neighboring application and reclaim the system resources 108 for the new online shopping application. Thus, instead of terminating other shopping applications which might be relevant for the user, the system 100 effectively terminates the applications using the neighboring concept and reclaims the system resources for any new activity or the application. Similarly, the system 100 applies neighboring concept for reclaiming the system resources 108 for other activities and/or applications 104.

A detailed description of the system 100 and/or modules 110, 112, 118, 120, and 122 is further explained in the following description.

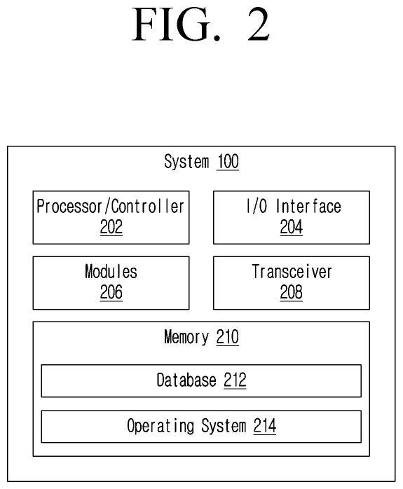

FIG. 2 illustrates a schematic block diagram of the system for reclaiming system resources, according to an embodiment of the disclosure.

Referring to FIG. 2, the system 100 may be configured to apply an RL model to adjust n amount of resources reclaimed from/for an activity (operation/feature) corresponding to an application (e.g., the application 104). This allows the system 100 to reclaim the minimum amount of resources necessary to ensure that the activity continues to function properly, while also preventing the system 100 from becoming overloaded.

The system 100 may include a processor/controller 202, an Input/Output (I/O) interface 204, one or more modules 206, a transceiver 208, and memory 210. The processor/controller 202 may be operatively coupled to each of the I/O interface 204, the modules 206, the transceiver 208 and the memory 210. The processor/controller 202 may include at least one data processor for executing processes in a Virtual Storage Area Network. The processor/controller 202 may include specialized processing units such as integrated system (bus) controllers, memory management control units, floating point units, graphics processing units, digital signal processing units, etc. In one embodiment, the processor/controller 202 may include a Central Processing Unit (CPU), a Graphics Processing Unit (GPU), or both. The processor/controller 202 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor/controller 202 may execute a software program, such as code generated manually (i.e., programmed) to perform the desired operation.

The processor/controller 202 may be disposed in communication with one or more I/O devices via the I/O interface 204. The I/O interface 204 may employ communication Code-Division Multiple Access (CDMA), High-Speed Packet Access (HSPA+), Global System for Mobile communications (GSM), Long-Term Evolution (LTE), Worldwide interoperability for Microwave Access (WiMAX), or the like, etc.

Using the I/O interface 204, the system 100 may communicate with one or more I/O devices, specifically, to the electronic device 102. Other examples of the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

The processor/controller 202 may communicate with a communication network via a network interface. The network interface may be the I/O interface 204. The network interface may connect to the communication network to enable connection of the system 100 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area Network (LAN), Wide Area Network (WAN), wireless network (e.g., using Wireless Application Protocol), the internet, etc. Using the network interface and the communication network, the system 100 may communicate with other devices.

The processor/controller 202 may be configured to identify an initialization of an activity corresponding to a first application associated with the electronic device 102. The processor/controller 202 may identify the initialization of the activity based on one or more user inputs. Such one or more user inputs may include hovering over a touch screen of the electronic device 102, a touch on the touch screen, a keypad input, a button press, and so forth. The processor/controller 202 may monitor the AMS 111 to identify the initialization of the activity. The processor/controller 202 may be configured to receive the one or more user inputs corresponding to the activity via the AMS 111. The processor/controller 202 may be configured to determine whether a combination of the activity and the first application is defined in the resource pool database 114. The processor/controller 202 may be configured to generate a hash value for the combination of the activity and the corresponding first application and search the generated hash value in the resource pool database 114.

Upon determining that the combination of the activity and the first application is not defined in the resource pool database, the processor/controller 202 may monitor resource consumption by the activity. The processor/controller 202 may store/update the combination of the activity and the first application with the monitored resource consumption in the resource pool database 114. The processor/controller 202 may generate the hash value for the combination of the activity and the corresponding first application. Thereafter, the processor/controller 202 may store the hash value and the monitored resource consumption in the resource pool database 114.

Upon determining that the combination of the activity and the first application is defined in the resource pool database 114, the processor/controller 202 may reclaim the system resources 108 corresponding the combination of the activity and the first application based on the resource pool database 114. The processor/controller 202 may be configured to reclaim the system resources 108 for the combination of the activity and the first application based on the amount of the system resources 108 associated with said combination of the activity and the first application in the resource pool database 114.

The processor/controller 202 may also determine whether the system resources 108 available at the electronic device 102 are sufficient to execute the activity corresponding to the first application. Upon determining the system resources 108 available at the electronic device 102 are insufficient to execute the activity corresponding to the first application, the processor/controller 202 may identify one or more second applications running on the electronic device 102. The processor/controller 202 may identify one or more second applications running on the electronic device 102. The processor/controller 202 may terminate at least one of the one or more second applications based on the corresponding identified context information. The processor/controller 202 may classify each of the one or more second applications as at least one of a neighboring application or a non-neighboring application based on the identified context information. The processor/controller 202 may terminate the at least one of the one or more second applications classified as the non-neighboring application. According to an embodiment of the disclosure, the processor/controller 202 may identify one or more operational characteristics of each of the one or more second applications. Examples of such operational characteristics may include, but are not limited to, a category, an application associativity frequency, a size, and resource utilization of the corresponding application. The processor/controller 202 may then determine a neighborhood value corresponding to each of the one or more second applications based on the identified one or more operational characteristics. Further, the processor/controller 202 may terminate the at least one of the one or more second applications based on the determined neighborhood score. A higher neighborhood score may indicate that the second application is similar to the first application, and the processor/controller 202 may terminate the second application with lower neighborhood scores.

The processor/controller 202 may further monitor the performance of the activity each time the activity is executed. The processor/controller 202 may update the RL model based on the monitored performance of the activity. The processor/controller 202 may take the monitored performance as feedback to improve the performance of the RL model. The processor/controller 202 may implement various techniques such as, but not limited to, image processing, data extraction, Artificial Intelligence (AI), Machine Learning (ML), Deep Learning (DL) and so forth, to achieve the desired objective.

The memory 210 may be communicatively coupled to the at least one processor/controller 202. The memory 210 may be configured to store data, and instructions executable by the at least one processor/controller 202. The memory 210 may include the resource pool database 114. The memory 210 may communicate via a bus within the system 100. The memory 210 may include, but is not limited to, a non-transitory computer-readable storage media, such as various types of volatile and non-volatile storage media including, but not limited to, Random Access Memory (RAM), Read-Only Memory (ROM), Programmable Read-Only Memory (PROM), electrically Programmable ROM, electrically erasable ROM, flash memory, magnetic tape or disk, optical media, and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

The modules 206 may be included within the memory 210. The memory 210 may further include a database 212 to store data. The database 212 may, for example, correspond to the resource pool database 114. The one or more modules 206 may include a set of instructions that may be executed to cause the system 100 to perform any one or more of the methods/processes disclosed herein. The modules 110, 112, 118, 120, and 122 (as shown in FIG. 1) may be a part of the modules 206. The one or more modules 206 may be configured to perform the steps of the disclosure using the data stored in the database 212, for reclaiming the system resources 108 in the electronic device 102 as discussed herein. Each of the one or more modules 206 may be a hardware unit which may be outside the memory 210. Further, the memory 210 may include an operating system 214 for performing one or more tasks of the system 100, as performed by a generic operating system in the communications domain. The transceiver 208 may be configured to receive and/or transmit signals to and from the electronic device 102 associated with the user. In one embodiment, the database 212 may be configured to store the information as required by the one or more modules 206 and the processor/controller 202 to perform one or more functions for reclaiming the system resources 108 in an electronic device 102.

Further, the disclosure contemplates a computer-readable medium that includes instructions or receives and executes instructions responsive to a propagated signal. The instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection, or may be established wirelessly. Likewise, the additional connections with other components of the system 100 may be physical or may be established wirelessly. The network may alternatively be directly connected to the bus. For the sake of brevity, the architecture, and standard operations of the operating system 214, the memory 210, the database 212, the processor/controller 202, the transceiver 208, and the I/O interface 204 are not discussed in detail.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

In the disclosure, being provided through learning means that, by applying a learning technique to a plurality of learning data, a predefined operating rule or AI model of the desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through the calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method for reclaiming system resources in the electronic device, the method may include using an artificial intelligence model to recommend/execute the plurality of instructions. The processor may perform a pre-processing operation on the data to convert the data into a form appropriate for use as an input for the artificial intelligence model. The artificial intelligence model may be obtained by training. Here, “obtained by training” means that a predefined operation rule or artificial intelligence model configured to perform the desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logical reasoning and predicting by determining information and includes, e.g., knowledge-based reasoning, optimization prediction, preference-based planning, or recommendation.

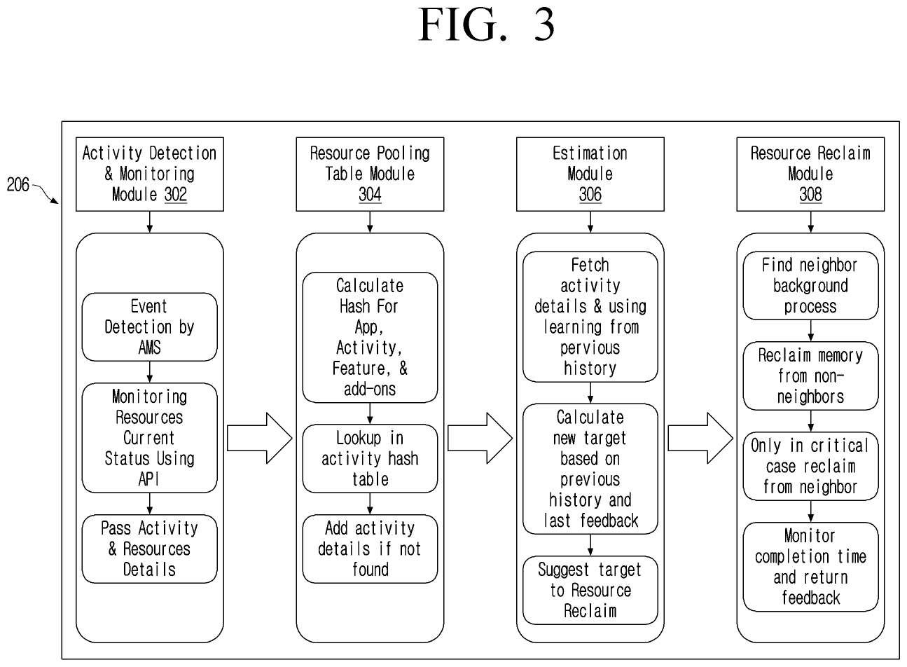

FIG. 3 illustrates a schematic workflow of various modules of the system, according to an embodiment of the disclosure.

Referring to FIG. 3, the modules 206 may include an activity detection and monitoring module 302, a resource pooling table module 304, an estimation module 306, and a resource reclaim module 308.

The activity detection and monitoring module 302 may correspond to a combination of the activity detection module 110 and the monitoring process module 112, as shown in FIG. 1. Initially, the activity detection and monitoring module 302 may perform event detection via the AMS 111. The activity detection and monitoring module 302 may monitor a current status of the system resources 108 using one or more Application Programming Interfaces (APIs). The APIs may enable the applications 104 to communicate with each other and/or the modules 206. The APIs may define methods and data formats to request and exchange information or functionality between different applications 104 and/or the modules 206. Thereafter, the activity detection and monitoring module 302 may collect and share activity and resource consumption details with the resource pooling table module 304. The resource pooling table module 304 may determine and/or calculate a hash value corresponding to the activity and associated application. In some embodiments, the resource pooling table module 304 may also consider the various add-ons and/or functions corresponding to the activity and/or the application to generate the corresponding hash value. In case of an event corresponding to an initialization of a new activity and/or an application, the resource pooling table module 304 may be configured to look for the combination of the activity and/or the application in the resource pool database 114 (i.e., a hash table). Further, in case the combination of the activity and/or the application is not found in the resource pool database 114, the resource pooling table module 304 may add said combination to the resource pool database 114. For every new record, the resource pooling table module 304 may create a new entry in the resource pool database 114.

The estimation module 306 may communicate with the resource pooling table module 304 and fetch/retrieve information corresponding to an activity (for example, the new activity) as stored in the resource pool database 114. The estimation module 306 may correspond to the estimation module 120, as shown in FIG. 1. Further, the estimation module 306 may extract feedback of the performance of the activity in view of corresponding information. The estimation module 306 may update the retrieved information corresponding to the activity based on the extract feedback corresponding to the application, to improve the overall performance of the system 100. The estimation module 306 may generate one or more suggestions corresponding to the updates in the retrieved information for the resource reclaim module 308 to enable effective resource reclaiming for the new activity and/or the application.

The resource reclaim module 308 may receive the one or more suggestions from the estimation module 306 and utilize the received one or more suggestions for reclaiming the system resources 108 for the new activity and/or the application. The resource reclaim module 308 may correspond to the resource reclaim module 122, as shown in FIG. 1. The resource reclaim module 308 may identify neighboring background process, i.e., the activities and/or the applications which are running in the background and have similar context with the new activity and/or the application. The resource reclaim module 308 may reclaim the system resources 108 from the non-neighboring activities and/or applications. However, in case, the resource reclaim module 308 identifies a need of more system resources 108 based on the one or more suggestions of the estimation module 308, and/or the information stored in the resource pool database 114, the resource reclaim module 308 may reclaim the system resources 108 from the neighboring activities and/or the applications. The resource reclaim module 308 may further be configured to monitor the completion time of the new activity and/or the application and store the monitored completion time as feedback for the estimation module 306.

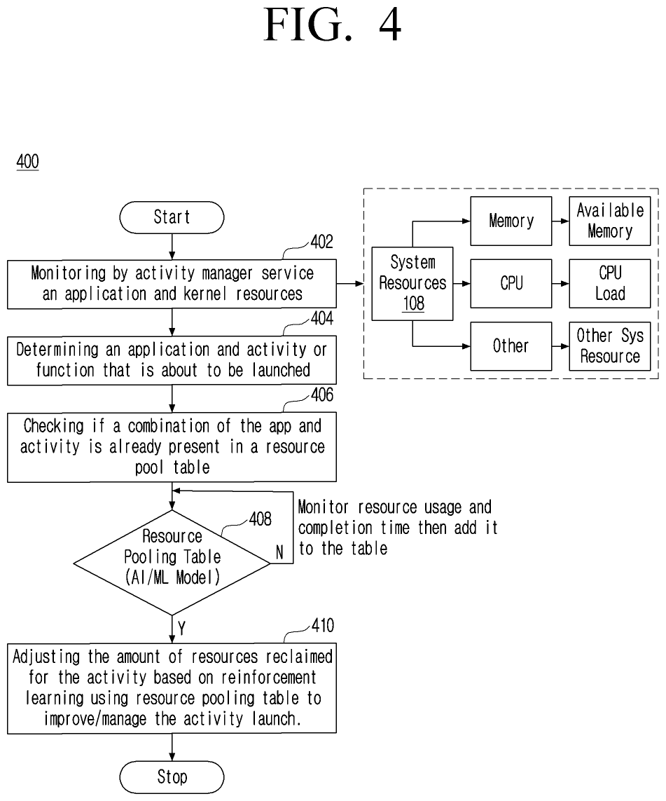

FIG. 4 illustrates a flow chart of a method 400 for reclaiming system resources in the electronic device, according to an embodiment of the disclosure. The method 400 may be implemented by the one or more components of the system 100 as shown in FIGS. 1 to 3.

Referring to FIG. 4, at operation 402, the method 400 may include monitoring one or more applications and utilization of kernel resources (i.e., the system resources 108). The one or more applications may correspond to the applications already running on the electronic device 102. The system resources 108 may include the memory and corresponding availability, the CPU and corresponding load, and/or the other resources and corresponding availability and/or load.

At operation 404, the method 400 may include determining an application and an activity or a function that is about to be launched or has been initialized by the user. For instance, if the user has executed a camera application, the method 400 may include determining the user might open/execute “video mode” (i.e., the activity) based on user preferences and/or previous history. Similarly, if the user is hovering over a shopping application, the method 400 may include determining that the user might open and/or execute the shopping application. Thus, the method 400 may include determining the application, the activity, or the function which is about to be launched or has been initialized by the user based on one or more user inputs, user preferences, and/or past usage-history of the user.

At operation 406, the method 400 may include checking if a combination of the application and the associated activity is present in the resource pool database 114.

At operation 408, the method 400 may include utilizing the resource pool database and/or the AI/ML model to determine/check if the combination of the application and the associated activity is present in the resource pool database 114. Upon determining that the combination of the application and the associated activity is not present in the resource pool database 114, the method 400 may include monitoring the resource consumption of the combination and storing the monitored resource consumption information in the resource pool database 114.

However, upon determining that the combination of the application and the associated activity is present in the resource pool database 114, at operation 410, the method 400 may include adjusting the amount of system resources reclaimed for the activity based on reinforcement learning using the resource pooling table 114 to improve/manage the launch of the activity.

Thus, the method 400 may include launching an application and/or an activity effectively and effectively.

The method 400 may include any additional step to perform the desired objective of the disclosure. Further, the steps of the method 400 may be performed in any suitable manner in order to achieve the desired advantages.

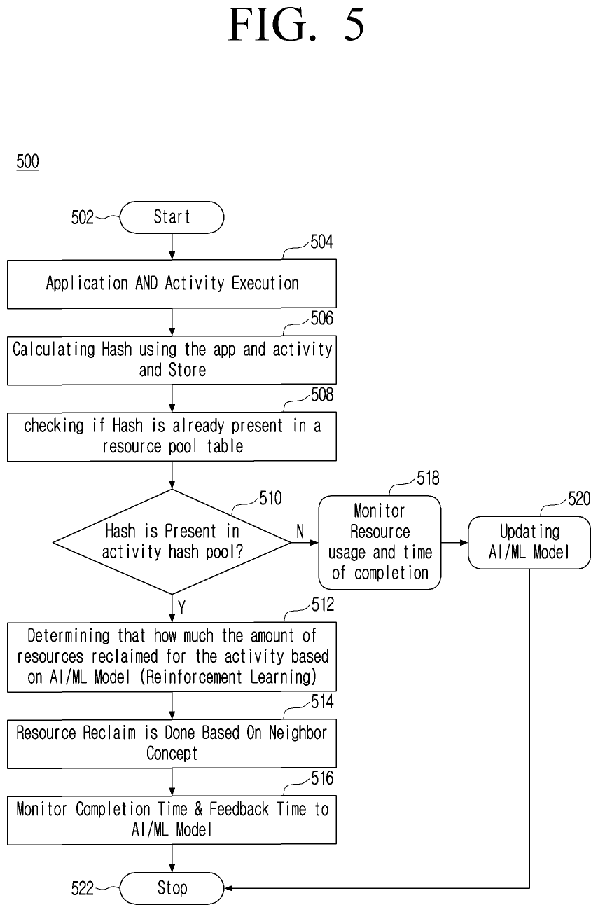

FIG. 5 illustrates a flow chart of a method 500 of learning for reclaiming the system resources in the electronic device, according to an embodiment of the disclosure. The method may be implemented by the one or more components of the system as shown in FIGS. 1 to 3.

Referring to FIG. 5, at operation 504, the method 500 may include executing the activity and/or corresponding application on the electronic device 102. At operation 506, the method 500 may include calculating/determining a hash value corresponding the activity and/or the application and storing the calculated hash value in the memory 210.

At operation 508, the method 500 may include checking if the calculated hash value is already present in the resource pool table 114. At operation 510, the method 500 may include a decision box to determine whether the calculated hash value is present in the resource pool table 114. Upon determining that the calculated hash value is not present in the resource pool table 114, at operation 518, the method 500 may include monitoring the usage of the system resources 108 and a time of completion of the activity and/or the application. Next, at operation 520, the method 500 may include updating AI/ML model based on the monitored usage and time of completion.

However, upon determining that the calculated hash value is present in the resource pool table 114, at operation 512, the method 500 may include determining an amount of system resources reclaimed for the activity based on AI/ML Model (Reinforcement Learning). At operation 514, the method 500 may include reclaiming the system resources based on the information stored in the resource pool table 114 and/or neighboring concept, as discussed above.

At operation 516, the method 500 may include monitoring the time of completion of the activity and sharing the monitored time of completion with the AI/ML model as a feedback. Thus, the system 100 may improve with every execution of the activity and/or the application.

The method 500 may include any additional step to perform the desired objective of the disclosure. Further, the steps of the method 500 may be performed in any suitable manner in order to achieve the desired advantages.

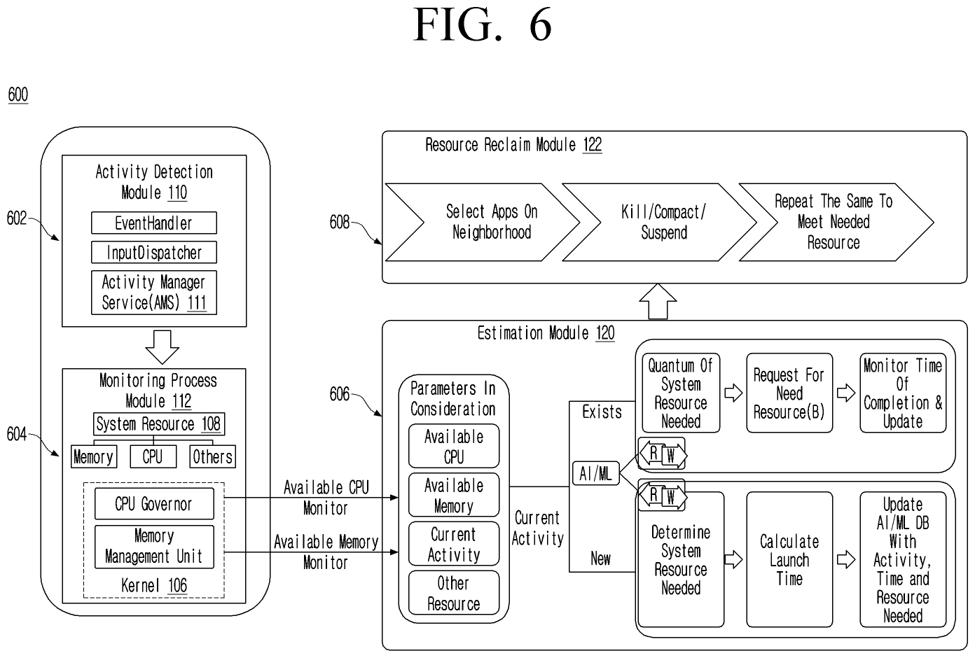

FIG. 6 illustrates a schematic block diagram of a workflow 600 of the system for reclaiming the system resources, according to an embodiment of the disclosure. FIG. 6 may further explain the steps of the methods 400 and 500, as shown in FIGS. 4 and 5, respectively.

Referring to FIG. 6, at block 602, the activity detection module 110 may execute one or more functions such as, eventhandler and inputDispatcher. The function eventhandler may be configured to detect an event corresponding to an activity and/or the application on the electronic device 102. The function inputDispatcher may be configured to share the detected event with the corresponding application. For instance, an event may correspond to a touch on an icon of a gaming application. The function eventhandler as executed by the activity detection module 110 may be configured to detect said event. Further, the function inputDispatcher as executed by the activity detection module 110 may be configured to share said detected event with the intended gaming application. Further, the activity detection module 110 may communicate with the AMS 111 to execute the activity and/or application based on the detected event.

At block 604, the monitoring process module 112 may monitor the system resources 108 and determine a current status of each of the system resources 108, i.e., the CPU, the memory, and the other resources. In one embodiment, the monitoring process module 112 may be configured to the kernel 106 to determine the current stats of the system resources 108. The kernel 106 may include a CPU governor configured to monitor load on the CPU and determine CPU availability based on the monitored load. The kernel 106 may include a memory management unit configured to monitor the memory (i.e., RAM) of the electronic device 102 and determine availability of the memory resource. The monitoring process module 112 may be configured to share the determined availability of the system resources 108 with the estimation module 120.

At block 606, the estimation module 120 may consider various parameters including the received availability of the system resources 108 to generate one or more suggestions for the resource reclaim module 122. The parameters may include identification of current activities, and availability of the other resources. The estimation module 120 may determine if the activity corresponding to the detected event is available in the resource pool database 114. Upon determining that the activity exists in the resource pool database 114, the estimation module 120 may determine a quantum of the system resources 108 required for the execution of the activity based on the resource pool database 114. Thereafter, the estimation module 120 may request for the required system resources 108 and monitor the time of completion of the activity. The estimation module 120 may generate one or more generation of the resource reclaim module 122 based on the monitored time of completion. The estimation module 120 may also update the AI/ML model for the activity based on the monitored time of completion. However, upon determining that the activity does not exist in the resource pool database 114, the estimation module 120 may determine the system resources 108 required for the execution of the activity based at least on a request from the activity. The estimation module 120 may also determine the launch time of the activity. The estimation module 120 may update AI/ML database, i.e., the resource pool database 114 with the activity, the completion time, and the system resource required for the execution of the activity.

At block 608, the resource reclaim module 122 may reclaim the system resources 108 for the activity based on the neighboring concept, as discussed above. The resource reclaim module 122 may identify the neighboring and non-neighboring activities and kill, suspend, or compact the non-neighboring activities to perform reclaiming of the system resources 108 for the activity. The resource reclaim module 122 may repeat these operations until the resource requirement for the activity is fulfilled.

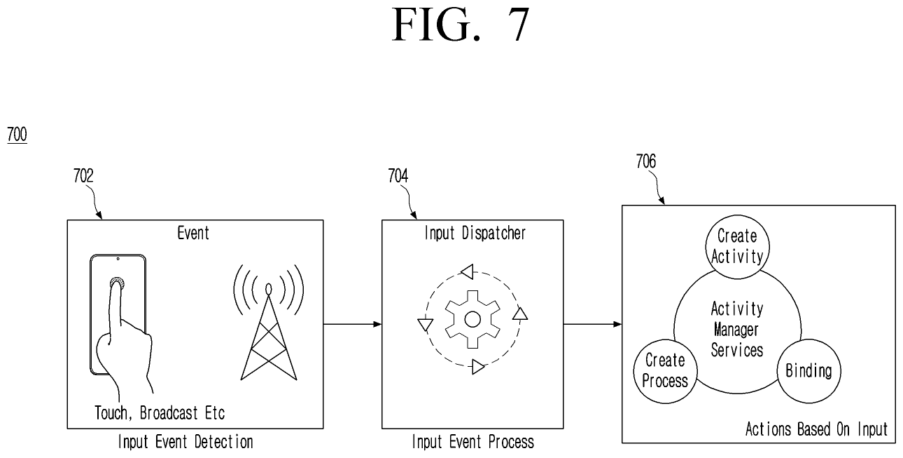

FIG. 7 illustrates a schematic workflow 700 of the activity detection module, according to an embodiment of the disclosure.

Referring to FIG. 7, block 702 may correspond to an event as detected by the activity detection module 110. As illustrated, the event may correspond to a touch on a display screen of the electronic device 102 or a broadcast signal received by a communication application. For a touch-based event, the activity detection module 110 may detect the event using a touch driver installed on the electronic device 102 and share the event with the Input Dispatcher block 704.

Block 704 may correspond to an event processing block or the input dispatcher. The input dispatcher may be configured to share the detected event with the intended application. For instance, a touch-based event on the camera application may be shared with the camera application by the input dispatcher.

Block 706 may correspond to AMS 111. The AMS 111 may be configured to initialize a life cycle of the intended application corresponding to the detected event. The AMS 111 may be configured to perform operations such as, but not limited to, creating an activity, binding the activity, and creating processes corresponding to the activity.

The activity detection module 110 may be configured to use various variables to define different functions/terms/operations. For instance:
AP=Application Name, APi=Application Name (i), Length=Name Length
AC=Activity, ACi=Activity Name (i)
AFi=Feature, AFi=Feature Name (i)

Here, the variable AP may correspond to Application Name, for example, a camera application. If there are multiple applications, the variable APi may be used to distinguish each application name. Similarly, the variable AC may be used for activity associated with the application, and the variable AFi may be used for the functions of the activity and/or the application.

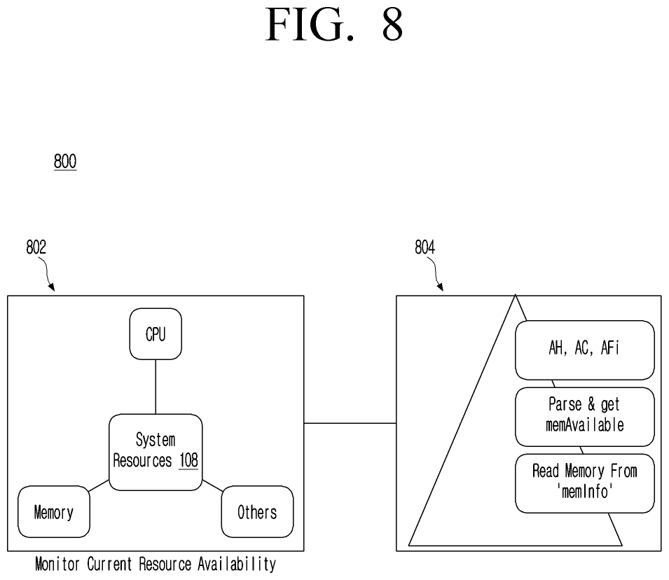

FIG. 8 illustrates a schematic workflow 800 of the monitoring process module, according to an embodiment of the disclosure.

Referring to FIG. 8, at block 802, the monitoring process module 112 may be configured to monitor the current activities and/or the applications, along with the availability of the system resources 108. The monitoring process module 112 may determine the current status i.e., the availability of the system resources 108 using variables “CpuInfoReader” and “MeminfoReader”. In some embodiments, the variable “CpuInfoReader” and “MeminfoReader” may be determined kernel 106 of the electronic device 102.

On successful execution of the activity, at block 804, the monitoring process module 112 may calculate a hash value for the activity, the application, features/functions, or add-ons.

The monitoring process module 112 may use following equations (Equations 1 to 3) to determine different hash values:

$$Equation 1$$

$$AH = ( {\sum }_{i = 0}^{i = length} ( ( AH ≪ 5 ) + AH + APi ) \% AH\_Max ) \% AH\_Max$$

$$Equation 2$$

$$AC = ( {\sum }_{i = 0}^{i = length} ( ( AC ≪ 5 ) + AC + ACTi ) \% AC\_Max ) \% AC\_Max$$

$$Equation 3$$

$$AFi = ( {\sum }_{i = 0}^{i = length} ( ( AFi ≪ 5 ) + AFi + Fi ) \% AFi\_Max ) \% AFi\_Max$$

Here, AH may correspond to Application Hash or a hash value corresponding to the application.

Similarly, AC may correspond to Activity Hash and AF may correspond to Feature Hash.

The variables AH_Max, AC_Max, and AFi_Max may be defined as shown in Table 1:

TABLE 1

| Variable | Description | Value |
|---|---|---|
| AH_Max | Application hash maximum | 1000 |
| | length | |
| AC_Max | Activity hash maximum length | 100 |
| AFi_Max | Feature hash maximum length | 100 |

In a non-limiting example, various application and corresponding activities and features are shown in Table 2 below:

TABLE 2

| Application | Activity | Feature1 | Feature2 | Feature3 |
|---|---|---|---|---|
| Camera | VideoRecording | SlowMotion | 64 MP | Night |
| | | | | Mode |
| Video | WatchVideo | Full HD | DarkMode | FullScreen |
| Streaming | | | | |
| Message | Compose | Attachment | Large File | NA |

The hash values corresponding to various applications, activities, and features as described in Table 2, as determined by the monitoring process module 112 using the above-mentioned equations (i.e., Equations 1 to 3) may be defined as shown in Table 3 below:

TABLE 3

| Application | Activity | Feature1 | Feature2 | Feature3 |
|---|---|---|---|---|
| (AH) | (AC) | (AF1) | (AF2) | (AF3) |
| 414 | 69 | 56 | 48 | 20 |
| 298 | 27 | 8 | 28 | 92 |
| 346 | 91 | 54 | 44 | NA |

The resource pooling table 114 may be configured to store the hash values corresponding to the application, the activities, and/or the features along with activity details such as, a look up value and resource utilization calculation. Such activity details may be determined by the system 100 using the following Equations 4 and 5:

$$RU = {\sum }_{i = 0}^{i = count} mem\_alloc \_size ( i ) \qquad Equation 4$$

$$LH = ( ( {\sum }_{i = 0}^{i = length} AFi ) * AH * AC ) \% LH\_Max \qquad Equation 5$$

Here, RU may correspond to resource utilization calculation and LH may correspond to Look up hash calculation from AC, AH, and AFi. Further, in an embodiment, LH_Max=100000.

The resource pooling table 114 may include all the information as determined using the above Equations 1 to 5.

Corresponding to the applications, the activities, and the features defined in Table 2, the respective hash calculation including a value of lookup hash may be defined as shown in Table 4 below:

TABLE 4

| | | | | | Lookup |
|---|---|---|---|---|---|
| Application | Activity | Feature1 | Feature2 | Feature3 | Hash |
| (AH) | (AC) | (AF1) | (AF2) | (FH3) | (LH) |
| 414 | 69 | 56 | 48 | 20 | 42184 |
| 298 | 27 | 8 | 28 | 92 | 29888 |
| 346 | 91 | 54 | 44 | 0 | 85628 |

A hash pool table may be generated as a part of the resource pooling table 114. The hash pool table may include hash indexes, activity table indexes, and AI/ML table indexes. An activity pool table with indexes is shown in Table 5 below:

TABLE 5

| | Applica- | | | | |
|---|---|---|---|---|---|
| Index | tion | Activity | Feature1 | Feature2 | Feature3 |
| 0 | Camera | VideoRe- | SlowMotion | 64 MP | Night |
| | | cording | | | Mode |
| 1 | Video | WatchVideo | Full HD | DarkMode | FullScreen |
| | Streaming | | | | |
| 2 | Message | Compose | Attachment | Large File | NA |

Further, a hash pool table corresponding to the applications, the activities, and the features highlighted in Table 5 may be represented as shown in Table 6 below:

TABLE 6

| HashIndex | Activity Table Index | AI/ML Table Index |
|---|---|---|
| . . . | . . . | . . . |
| 29888 | 1 | 0 |
| . . . | . . . | . . . |
| 42184 | 0 | 1 |
| . . . | . . . | . . . |
| 85628 | 2 | 2 |

The hash pool table may include the AI/ML table index for each activity. The AI/ML table may represent activity history which may be used by the estimation module 120 as feedback and/or to estimate new target resource calculation.

An AI/ML table may be represented as shown in Table 7 below:

TABLE 7

| | Last | Mean | Mean | | | |
|---|---|---|---|---|---|---|
| | Entry | Entry | Entry | | Target | |
| Index | Time(sec) | (25) | (5) | Feedback | (MB) | Action Done |
| 0 | 2 | 2.5 | 2.2 | 100 | 225 | + |
| 1 | 2.5 | 2.3 | 2.1 | −100 | 725 | + |
| 2 | 1 | 1.07 | 1.03 | −100 | 250 | − |

The estimation module 120 may be configured to identify a target amount of the system resources 108 required for execution of the activity using the following Equation 6:

$$Equation 6$$

$$N\_TH = ( ( ( log ( {\sum }_{i = 0}^{i = Tsize} {En}_{time} / L\_En ) * L\_FB ) * ( \sqrt{\sum {( ENi - Mn )}^{2} / N )} ) * L\_TH ) / 100 ) + L\_TH ) * is\_create$$

Here, N_TH may correspond to the new target for system resource, L_TH may correspond to last target of the system resource as tried by the activity, L_FB may correspond to last feedback, and M_En may correspond to mean of last 25 entry time.

Further, L_En may correspond to last entry time. D_TH may correspond to 5 (ignore if delta is less than 5%) and Tsize may correspond to 25 (i.e., a number of entry to consider).

The expression (Σᵢ₌₀^{i=Tsize}Enₜᵢₘₑ) may correspond to mean of entry time. The expression (log(Σᵢ₌₀^{i=Tsize}Enₜᵢₘₑ/L_En) may correspond to log of mean after dividing by last entry. The expression ({square root over (Σ(EN(i=0 to 5)−Mn)²/N)} may correspond to standard deviation in entry time data.

Some target values of the system resources 108 (specifically, the memory) as determined by the estimation module 120 are provided in Table 8 below:

TABLE 8

| | Last Entry | Mean Entry | Last | |
|---|---|---|---|---|
| Last Target | Time | Time | Feed | New Target |
| (MB) | (Sec) | (Sec) | Back | Calculated |
| 500 | 3 | 2 | −Ve | 535 |
| 500 | 2 | 3 | +Ve | 465 |
| 750 | 4.5 | 6.75 | +Ve | 776 |
| 450 | 3.5 | 3.45 | 0 | 450 |

In a non-limiting example, if a camera application is launched in video mode with slow motion feature and in 64 Mega Pixel resolution. The estimation module 120 may extract information from the activity pool table along with the feedback information and generate the one or more suggestions for the target amount of the system resources as follows:

Camera: Calculate New Target

| Last Five Camera | 3.1 | 4.2 | 5 | 7 | 4 |
|---|---|---|---|---|---|
| Entry Time(Sec) | | | | | |
| Mean Entry | 4.66 | | | | |
| Entry Time − Mean | −1.56 | −0.46 | 0.34 | 2.34 | −0.66 |
| Square Of Delta | 2.4336 | 0.2116 | 0.1156 | 5.4756 | 0.4356 |
| (Entry − Mean) | | | | | |
| Total Sum(Square Of | 1.7344 | | | | |
| Delta)/N | | | | | |
| STD After New | 1.32 | | | | |
| Launch | | | | | |
| Last Feedback | 100 | | | | |
| Mean_Entry/New | 1.17 | | | | |
| Entry | | | | | |
| Log | 0.07 | | | | |
| Log * Feedback | 6.63 | | | | |
| Old Target Memory | 700 | | | | |
| (MB) | | | | | |
| New Target Memory | 653.57 | | | | |
| (MB) | | | | | |

Therefore, based on extracted information, the estimation module 120 identifies that previous record indicate that increasing target amount did showed significant improvement therefore the target amount of the system resources should be reduced. The estimation module 120 may similarly calculate the target amount of the system resources 108 for the other activities and/or associated applications 104.

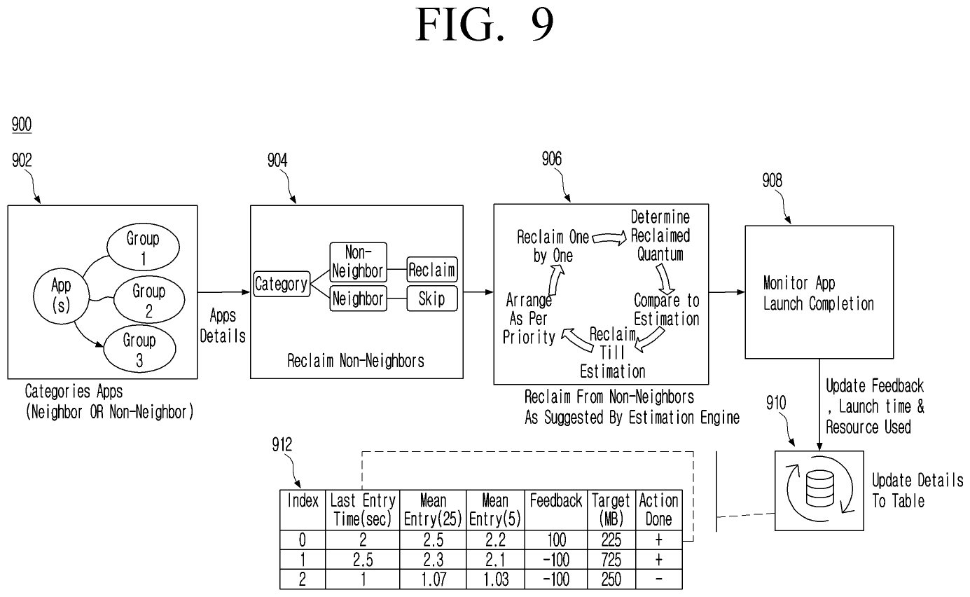

FIG. 9 illustrates a schematic workflow 900 of the resource reclaim module, according to an embodiment of the disclosure.

Referring to FIG. 9, at block 902, the resource reclaim module 122 may categorize the applications into one or more groups for example, Group 1, Group 2, and Group 3. The resource reclaim module 122 may categorize the application into the one or more groups based on parameters such as, but not limited to, application categories, applications associated frequencies, application sizes, application CPU utilization, and so forth.

At block 904, the resource reclaim module 122 may further categorize the groups of the applications into neighbouring applications and non-neighbouring applications. After receiving a target amount of the system resources 108 required for the application, the resource reclaim module 122 may reclaim the system resources 108 from the non-neighbouring applications based on the requirements of the system resources 108 and skip the neighbouring applications.

At block 906, the resource reclaim module 122 may reclaim the system resources 108 from the non-neighbouring applications based on the one or more suggestions, as provided by the estimation module 120. The resource reclaim module 122 may determine a quantum of the system resources 108 required for the activity. The resource reclaim module may compare the determined quantum of the system resources 108 with the quantum of the system resources 108 as suggested by the estimation module 120. The resource reclaim module 122 may reclaim the system resources 108 until the requirement of the activity is met. In some embodiment, the resource reclaim module 122 may terminate non-neighbouring applications one by one to make the system resources 108 available for activity.

At block 908, the resource reclaim module 122 may monitor the execution of the activity based on the reclaimed system resources. Such monitoring may include, but is not limited to, monitoring a launch time of activity, a time of completion of the activity, and so forth.

At block 910, the monitored information corresponding to the activity may be used to update the resource pool database 114. For instance, an update in the resource pool database has been highlighted as block 912.

The resource reclaim module 122 may determine a neighboring score corresponding to each of the applications 104 running on the electronic device 102 to categorize the applications 104 as the neighbouring application or the non-neighbouring applications.

The resource reclaim module 122 may determine the neighbouring score based on following Equation 7:

$$Equation 7$$

$$N\_Score = ( ( App\_Ast + App\_Cat * 100 ) + ( 100 - App\_size ) + ( 100 - App\_CPU ) ) / 4 ;$$

Further, for an App (X) and an App (Y), the N_Score should be more than 50 then only Y will be neighbor to X.

The variables/parameters used in Equation 7 may be defined as:

| Parameters | Description |
|---|---|
| App_Cat | Application Category like(Game, Messenger, |
| | Shopping, SNS, Ticket |
| | Booking)(Cat(X) = Cat(Y)) |
| App_Ast | Application associativity frequency in %(Launch |
| | X −> Y) |
| App_Size | Application size in background in % of total |
| | memory capacity |
| App_CPU | Application CPU utilization in background in % |
| N_Score | Neighboring score |

A scenario of categorizing the applications as the neighbouring applications and the non-neighbouring applications by the resource reclaim module 122 has been explained in below Table 9:

TABLE 9

| App_Cat | App_Cat | App_Ast | App_Size | App_CPU | N_Score | |
|---|---|---|---|---|---|---|
| (X) | (Y) | (X -> Y) | (Y) | (Y) | (X -> Y) | Conclusion |
| Shopping | Shopping | 50 | 40 | 30 | 70 | Y is |
| | | | | | | neighbor |
| | | | | | | to X |
| Shopping | Game | 50 | 40 | 30 | 45 | Y is not a |
| | | | | | | neighbor |
| | | | | | | to X |
| Messaging | Messaging | 40 | 70 | 80 | 47 | Y is not a |
| | | | | | | neighbor |
| | | | | | | to X |

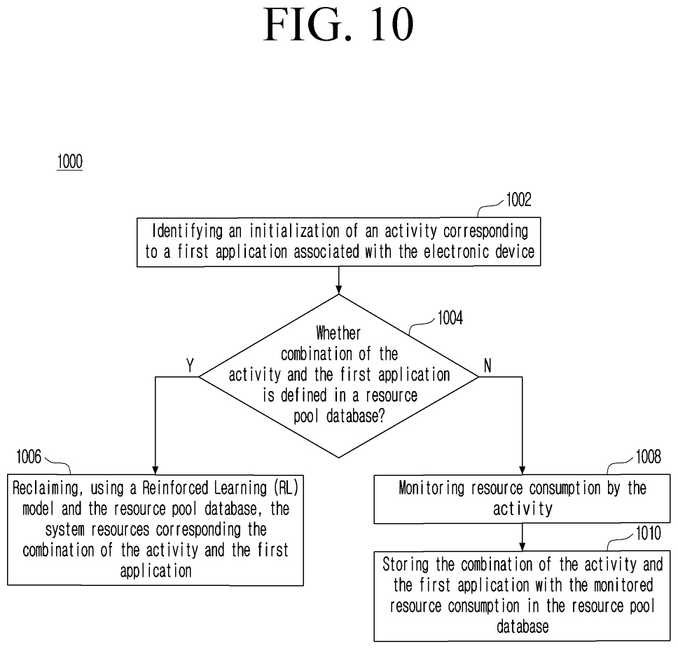

FIG. 10 illustrates a process flow of a method for reclaiming system resources in the electronic device, according to an embodiment of the disclosure.

Referring to FIG. 10, at operation 1002, the method 1000 includes identifying an initialization of an activity corresponding to a first application associated with the electronic device 102. In some embodiments, the method 1000 may include monitoring an activity manager service to identify the initialization of the activity. The method 1000 may include receiving, via the activity manager service, one or more user inputs corresponding to the activity to identify the initialization of the activity.

At operation 1004, the method includes determining whether a combination of the activity and the first application is defined in a resource pool database 114.

Upon determining that the combination of the activity and the first application is defined in a resource pool database 114, at operation 1006, the method 1000 includes reclaiming, using the RL model and the resource pool database 114, the system resources 108 corresponding the combination of the activity and the first application.

Upon determining that the combination of the activity and the first application is not defined in a resource pool database 114, at operation 1008, the method 1000 includes monitoring resource consumption by the activity. In one embodiment, the method 1000 may include generating a hash value for the combination of the activity and the corresponding first application and searching the hash value in the resource pool database 114. At operation 1010, the method 1000 includes storing the combination of the activity and the first application with the monitored resource consumption in the resource pool database 114. The method 1000 may include generating a hash value for the combination of the activity and the corresponding first application. The method 1000 may include storing the hash value and the monitored resource consumption in the resource pool database 114.

The method 1000 may also include determining whether the system resources available at the electronic device 102 are sufficient to execute the activity corresponding to the first application. Upon determining the system resources available at the electronic device is insufficient to execute the activity corresponding to the first application, the method 1000 may include identifying one or more second applications running on the electronic device 102. The method 1000 may include identifying context information corresponding to the first application and the one or more second applications. The method 1000 may include terminating at least one of the one or more second applications based on the corresponding identified context information. Next, the method 1000 may include reclaiming the system resources for the activity corresponding to the first application.

In some embodiments, the method 1000 may also include classifying each of the one or more second applications as at least one of a neighboring application or a non-neighboring application based on the identified context information. The method 1000 may include terminating the at least one of the one or more second applications classified as the non-neighboring application. The method 1000 may include identifying one or more operational characteristics of each of the one or more second applications, the one or more operational characteristics comprises a category, an application associativity frequency, a size, and resource utilization of the corresponding second application. The method 1000 may also include determining a neighborhood value corresponding to each of the one or more second applications based on the identified one or more operational characteristics. Moreover, the method 1000 may include terminating the at least one of the one or more second applications based on the determined neighborhood value.

The method 1000 may also include monitoring the performance of the activity and updating the RL model based on the monitored performance of the activity.

The method 1000 may include any additional step to perform the desired objective of the disclosure. Further, the steps of the method 1000 may be performed in any suitably manner in order to achieve the desired advantages.

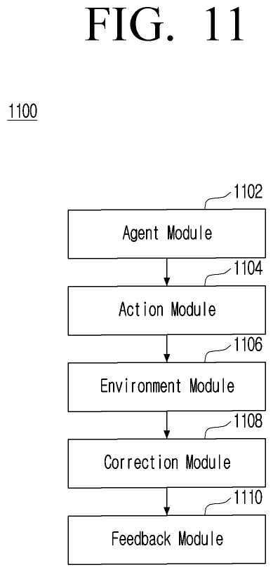

FIG. 11 illustrates a process flow of the RL model 1100 for reclaiming system resources in the electronic device, according to an embodiment of the disclosure.

Referring to FIG. 11, the RL model 1100 may be implemented by the system 100 to achieve the desired objective. Further, the RL model 1100 may train agents to make sequences of decisions in an environment for reclaiming system resources in the electronic device.

Block 1102 may represent an agent module (also referred to as the agent). The agent may correspond to the resource reclaim module 122 that may be configured to consider both activity and the associated application while reclaiming the system resources. The agent may be configured to receive input such as user input(s), information related to the activity and the application, and the like. The agent may be configured to receive following variables as shown in Table 10 below:

TABLE 10

| Variables | Description |
|---|---|
| N_TH | New Action(New Target Memory) |
| L_TH | Last Action(Last Target memory) |
| L_FB | Feedback Received after last action |
| M_En | Mean Of Last 25 Entry Time |
| L_En | Last Entry Time |
| D_TH | 5(Ignore if delta is less than 5%) |
| Tsize | 25(Number Of Entry To Consider) |
| is_create | If activity is being created or it exists. (Being Created: 1, |
| | Exists: 0) |

The agent may generate resource related information corresponding to the activity and associated application based on the received input. For instance, the agent may generate information such as, but not limited to, last memory target, feedback received after last action, a mean value of last 25 entry time, last entry time, if activity is being created or it exists, or current available memory status. While the examples of the information may correspond to the memory resource, the agent may generate similar information as the output for other resources.

Initially, the agent may generate a hash value corresponding to the received input information. The agent may then use the generated hash value to search a task i.e., the combination of the activity and associated application in the resource pool database 114. Thereafter, the agent may read/extract information associated with the task, and such information may include, but is not limited to, the last action, the last feedback, the mean, the last entry time, is_create (current if there is any new activity created or not). In some embodiments, the agent may read/extract the information using a global variable/function for example, “getMeminfo”.

Block 1104 may represent an action module. The action module may correspond to the estimation module 120. The action module may determine a new amount target resource to reclaim for the activity and the associated application. The action module may be configured to receive the output of the agent module as input and generate a new target memory to reclaim as an output. The action module may be configured to continuously update the system 100 with the changes in the applications and/or the corresponding activities. In some embodiments, the action module may use the following equation (Equation 8) to determine the new target memory to reclaim:

$$Equation 8$$

$$N\_TH = ( ( ( log ( {\sum }_{i = 0}^{i = Tsize} {En}_{time} / L\_En ) * L\_FB ) * ( \sqrt{\sum {( ENi - Mn )}^{2} / N )} ) * L\_TH ) / 100 ) + L\_TH ) * is\_create$$

Here, the variables of the Equation 8 may be defined as shown in Table 11 below:

TABLE 11

| Variables | Description |
|---|---|
| EN_V | Checking variation from mean to know current entry |
| | time is how much better or poor |
| Cur_Ent | Current Entry Time |
| Last_Act | Last target was increased or decreased (Increased = 1, |
| | Decreased = −1) |
| Mean_entry | Average of previous entry time |
| L_En | Last Entry Time |

The action module 1104 may share the determined the new target memory as input to an environment module 1106. The environment module 1106 may use the neighboring concept (as discussed above) to select a process to reclaim the determined new target memory. For instance, the environment module 1106 may analyze an environment of the electronic device and terminate applications using the neighboring concept to reclaim the memory according to new target memory information. The environment module 1106 may further calculate a new completion time of the activity (task). The environment module 1106 may monitor the activity to output a current entry time, a determination whether the new target is increased or decreased, and average of previous entry times.

The output of the environment module 1106 may be passed on to a correction module 1108 to output a validity of the current task. The correction module 1108 may determine a standard deviation using current entry time. The correction module 1108 may determine if the electronic device was stable while performing the activity/task using the new target memory. The correction module 1108 may compare the determined standard deviation with a predefined threshold value, for example, 1.5, to determine the stability of the electronic device and generation of a feedback. If the standard deviation is greater than the predefined threshold value, the correction module 1108 may consider the electronic device as non-stable. However, if the standard deviation is less than the predefined threshold value, the correction module 1108 may generate the feedback for the system 100. In an embodiment, the standard deviation may be determined using the following Equation 9:

$$STD = ( \sqrt{\sum {( ENi - Mn )}^{2} / N} ) \qquad Equation 9$$

The feedback by the correction module 1108 may be fed to a feedback module 1110. The feedback module 1110 may process the receive feedback to update the resource pool database 114. Specifically, the feedback module 1110 may be configured to calculate a mean entry time including the current entry time. The feedback module 1110 may perform logarithmic operation of the current entry time and the mean entry time. The feedback module 1110 may determine if current entry time is between than an average mean of a logarithmic value of the entry time obtained after the logarithmic operation. Accordingly, the feedback module 1110 may generate a feedback to update the database pool database 114. For instance, the feedback module 1110 may determine that the target reclaim amount was increased but there was no significant improvement in the performance of the system 100, therefore the feedback module 1110 may generate a negative feedback. However, if a target reclaim amount was increased and there was some improvement in the performance of the system 100, the feedback module 1110 may generate a positive feedback. Similarly, the feedback may be generated when the target reclaim amount is decreased. Based on the generated feedback, the RL model 1110 may update the resource pool database 114 and the system 100 may perform operation of reclaiming the resource resources, accordingly.

Thus, the disclosure provides an efficient resource reclaiming process for effective execution of the activity and/or the application in the electronic device 102.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for reclaiming system resources in an electronic device, the method comprising:
identifying an initialization of an activity corresponding to a first application associated with the electronic device;
determining whether a combination of the activity and the first application is defined in a resource pool database;
upon determining that the combination of the activity and the first application is not defined in the resource pool database:
monitoring resource consumption by the activity, and
storing the combination of the activity and the first application with the monitored resource consumption in the resource pool database; and
upon determining that the combination of the activity and the first application is defined in the resource pool database, reclaiming, using a reinforced learning (RL) model and the resource pool database, the system resources corresponding the combination of the activity and the first application.

2. The method as claimed in claim 1, wherein identifying the initialization of the activity corresponding to the first application comprises:
monitoring an activity manager service to identify the initialization of the activity.

3. The method as claimed in claim 2, further comprising:
receiving, by the activity manager service, one or more user inputs corresponding to the activity; and
identifying the initialization of the activity based on the received one or more user inputs by the activity manager service.

4. The method as claimed in claim 1, further comprising:
determining whether the system resources available at the electronic device are sufficient to execute the activity corresponding to the first application; and
upon determining the system resources available at the electronic device is insufficient to execute the activity corresponding to the first application:
identifying one or more second applications running on the electronic device,
identifying context information corresponding to the first application and the one or more second applications,
terminating at least one of the one or more second applications based on the corresponding identified context information, and
reclaiming the system resources for the activity corresponding to the first application.

5. The method as claimed in claim 4, further comprising:
classifying each of the one or more second applications as at least one of a neighboring application or a non-neighboring application based on the identified context information; and
terminating the at least one of the one or more second applications classified as the non-neighboring application.

6. The method as claimed in claim 4, further comprising:
identifying one or more operational characteristics of each of the one or more second applications, the one or more operational characteristics comprises a category, an application associativity frequency, a size, and resource utilization of the corresponding second application;
determining a neighborhood value corresponding to each of the one or more second applications based on the identified one or more operational characteristics; and
terminating the at least one of the one or more second applications based on the determined neighborhood value.

7. The method as claimed in claim 1, wherein determining whether the combination of the activity and the first application is defined in the resource pool database comprises:
generating a hash value for the combination of the activity and the corresponding first application; and
searching the hash value in the resource pool database.

8. The method as claimed in claim 1, wherein storing the combination of the activity and the first application with the monitored resource consumption in the resource pool database comprises:
generating a hash value for the combination of the activity and the corresponding first application; and
storing the hash value and the monitored resource consumption in the resource pool database.

9. The method as claimed in claim 1, further comprising:
monitoring a performance of the activity; and
updating the RL model based on the monitored performance of the activity.

10. The method as claimed in claim 1, wherein reclaiming the system resources for the activity comprises:
identifying a previous amount of the system resources utilized for the activity during one or more previous execution of the activity and corresponding feedbacks;
determining a target amount of the system resources for the activity based on the identified previous amount of system resources and corresponding feedbacks using the RL model; and
reclaiming the system resources for the activity based on the determined target amount of the system resources.

11. A system for reclaiming system resources in an electronic device, the system comprising:
memory storing one or more computer programs; and
one or more processors communicatively coupled to the memory,
wherein the one or more computer programs include computer-executable instructions that, when executed by the one or more processors individually or collectively, cause the system to:
identify an initialization of an activity corresponding to a first application associated with the electronic device,
determine whether a combination of the activity and the first application is defined in a resource pool database,
upon determining that the combination of the activity and the first application is not defined in the resource pool database:
monitor resource consumption by the activity, and
store the combination of the activity and the first application with the monitored resource consumption in the resource pool database, and
upon determining that the combination of the activity and the first application is defined in the resource pool database, reclaim, using a reinforced learning (RL) model and the resource pool database, the system resources corresponding the combination of the activity and the first application.

12. The system as claimed in claim 11, wherein, to identify the initialization of the activity corresponding to the first application, the one or more computer programs further include computer-executable instructions that, when executed by the one or more processors individually or collectively, cause the system to:
monitor an activity manager service to identify the initialization of the activity.

13. The system as claimed in claim 12, wherein one or more computer programs further include computer-executable instructions that, when executed by the one or more processors individually or collectively, cause the system to:
receive, via the activity manager service, one or more user inputs corresponding to the activity, and
identify the initialization of the activity based on the received one or more user inputs by the activity manager service.

14. The system as claimed in claim 11, wherein the one or more computer programs further include computer-executable instructions that, when executed by the one or more processors individually or collectively, cause the system to:
determine whether the system resources available at the electronic device are sufficient to execute the activity corresponding to the first application, and
upon determining the system resources available at the electronic device is insufficient to execute the activity corresponding to the first application:
identify one or more second applications running on the electronic device,
identify context information corresponding to the first application and the one or more second applications,
terminate at least one of the one or more second applications based on the corresponding identified context information, and
reclaim the system resources for the activity corresponding to the first application.

15. The system as claimed in claim 14, wherein the one or more computer programs further include computer-executable instructions that, when executed by the one or more processors individually or collectively, cause the system to:
classify each of the one or more second applications as at least one of a neighboring application or a non-neighboring application based on the identified context information, and
terminate the at least one of the one or more second applications classified as the non-neighboring application.

16. The system of claim 14, wherein the one or more computer programs further include computer-executable instructions that, when executed by the one or more processors individually or collectively, cause the system to:
identify one or more operational characteristics of each of the one or more second applications, the one or more operational characteristics comprises a category, an application associativity frequency, a size, and resource utilization of the corresponding second application,
determine a neighborhood value corresponding to each of the one or more second applications based on the identified one or more operational characteristics, and
terminate the at least one of the one or more second applications based on the determined neighborhood value.

17. The system of claim 14, wherein the memory further stores the resource pool database.

18. The system of claim 17, wherein the resource pool database stores hash values corresponding to the combination of the activity and the associated application.

19. One or more non-transitory computer-readable storage media storing one or more computer programs including computer-executable instructions that, when executed by one or more processors of an electronic device, cause the electronic device to perform operations, the operations comprising:
identifying an initialization of an activity corresponding to a first application associated with the electronic device;
determining whether a combination of the activity and the first application is defined in a resource pool database;
upon determining that the combination of the activity and the first application is not defined in the resource pool database:
monitoring resource consumption by the activity, and
storing the combination of the activity and the first application with the monitored resource consumption in the resource pool database; and
upon determining that the combination of the activity and the first application is defined in the resource pool database, reclaiming, using a reinforced learning (RL) model and the resource pool database, system resources corresponding the combination of the activity and the first application.

20. The one or more non-transitory computer-readable storage media of claim 19, the operations further comprising:
receiving, by an activity manager service, one or more user inputs corresponding to the activity; and
identifying the initialization of the activity based on the received one or more user inputs by the activity manager service.
